(19) United States
(12) Patent Application Publication
(10) Pub. No.: US 2025/0341420 A1
(43) Pub. Date: Nov. 6, 2025

(54) COLOR SENSING DEVICE AND OPTIMIZATION METHOD THEREOF

(71) Applicant: LITE-ON TECHNOLOGY CORPORATION, TAIPEI CITY (TW)

(72) Inventor: I-CHEN CHIEN, Keelung City (TW)

(21) Appl. No.: 19/013,764

(22) Filed: Jan. 8, 2025

Related U.S. Application Data
(60) Provisional application No. 63/640,902, filed on May 1, 2024.

(30) Foreign Application Priority Data
Oct. 21, 2024 (CN) 202411467683.1

(51) Int. Cl. G01J 3/02; G01J 3/10; G01J 5/60

(52) U.S. Cl. CPC G01J 3/0294; G01J 3/0297; G01J 3/108; G01J 5/60; G01J 2005/608

(57) ABSTRACT

A color sensing device and an optimization method thereof are provided. The light sensing elements have distinct native channels respectively, each native channel has a peak, and any two of the native channels that are adjacent partially overlap with each other and generate an intersection point, each native channel corresponds to the one intersection point or the two intersection points to define a central area and one or two edge areas. The light sensing elements detect a testing light source and generate initial responses. The processing circuit establishes derived channels based on the peaks and virtual channels based on the intersection points. The processing circuit converts the initial responses into derived responses and virtual responses. The color conversion model generates a color coordinate of the testing light source based on the derived responses and the virtual responses.

### CROSS-REFERENCE TO RELATED PATENT APPLICATION

This application claims the benefit of priorities to U.S. Provisional Patent Application No. 63/640,902, filed on May 1, 2024, and China Patent Application No. 202411467683.1, filed on Oct. 21, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosures relates to a light sensing device and an optimization method thereof, and more particularly to a light sensing device for detecting a color coordinate of a light source and an optimization method thereof.

### BACKGROUND OF THE DISCLOSURE

A human eye has high sensitivity to three specific bands of light. The central wavelengths of these three bands are 410 nm, 530 nm and 560 nm, respectively. Early color sensing devices are mainly aimed at stimulating the vision of the human eye.

With the advancement of electronic technology and consumers' increasing requirements for color resolution, color sensing devices that simply simulate human vision are no longer sufficient. Current color sensing devices must obtain more color information than the human eye. As a result, the number of color sensing channels of the color sensing device must be increased. However, an increase in the number of color sensing channels also relatively increases the manufacturing cost of the color sensing device. In addition, as the number of color sensing channels is increased, the number of times that photolithography and photoresist removal need be performed during the manufacturing process will also be increased. As the length of time and the number of times that the filter film of each channel comes in contact with chemical detergents become longer and more excessive, the yield of the color sensing device is decreased.

### SUMMARY OF THE DISCLOSURE

In response to the above-referenced technical inadequacy, the present disclosure provides a color sensing device and an optimization method thereof.

In order to solve the above-mentioned problem, one of the technical aspects adopted by the present disclosure is to provide a color sensing device. The color sensing device includes a plurality of light sensing elements, a processing circuit, and a storage circuit. The light sensing elements have a plurality of distinct native channels, each of the native channels has a peak, and any two of the native channels that are adjacent partially overlap with each other and defines an intersection point, each of the native channels corresponds to the one intersection point or the two intersection points to define a central area of the native channel and one or two edge areas of the native channel. The processing circuit is electrically connected to the light sensing elements. The storage circuit is electrically connected to the processing circuit and stores a color conversion model. The light sensing elements are configured to detect a testing light source and generate a plurality of initial responses. The processing circuit is configured to establish a plurality of derivative channels based on the peaks and a plurality of virtual channels based on the intersection points. The processing circuit is configured to convert the initial responses into a plurality of derived responses of the derived channels and a plurality of virtual responses of the virtual channel. The processing circuit is configured to access the storage circuit to execute the color conversion model. The color conversion model is configured to generate a color coordinate of the testing light source based on the derived responses and the virtual responses.

In order to solve the above-mentioned problem, another one of the technical aspects adopted by the present disclosure is to provide an optimization method of a color sensing device. The optimization method includes: detecting, by a plurality of light sensing elements, a testing light source to generate a plurality of initial responses; wherein the light sensing elements have a plurality of distinct native channels, each of the native channels has a peak, and any two of the native channels that are adjacent partially overlap with each other and defines an intersection point, each of the native channels corresponds to the one intersection point or the two intersection points to define a central area of the native channel and one or two edge areas of the native channel; establishing, by a processing circuit, a plurality of derivative channels according to a plurality of the peaks and a plurality of virtual channels according to the one intersection point or the two intersection points; converting, by the processing circuit, a plurality of the initial responses into a plurality of derived responses of the derived channels and a plurality of virtual responses of the virtual channels; accessing, by a storage circuit, the processing circuit to execute a color conversion model; generating, by the color conversion model, a color coordinate of the testing light source according to the derived responses and the virtual responses.

Therefore, in the color sensing device and the optimization method of the color sensing device provided by the present disclosure, the number of spectral channels of the color sensing device are increased without increasing hardware cost and production cycle. By way of incrementing the number of spectral channels, the color sensing device has higher resolution, higher sensitivity, more accurate information analysis, and higher yields.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a color sensing device according to a first embodiment of the present disclosure.

FIG. 2 is a schematic diagram of sensing distributions of native channels according to the first embodiment of the present disclosure.

FIGS. 3A-3D are spectrum diagrams of a part A of FIG. 2.

FIG. 4 is a schematic diagram of the sensing distributions of native channels according to a second embodiment of the present disclosure.

FIG. 5 is a schematic diagram of the sensing distributions of native channels according to a third embodiment of the present disclosure.

FIG. 6 is a schematic diagram of the color sensing device according to the second embodiment of the present disclosure.

FIG. 7 is a flow chart of a model training method of the color sensing device according to one embodiment of the present disclosure.

FIG. 8 is a flow chart of a calibration method of the color sensing device according to the first embodiment of the present disclosure.

FIG. 9 is a flow chart of the calibration method of the color sensing device according to the second embodiment of the present disclosure;

FIG. 10 is a flow chart of the calibration method of the color sensing device according to a third embodiment of the present disclosure.

FIG. 11 is a flow chart of the calibration method of the color sensing device according to a fourth embodiment of the present disclosure.

FIG. 12 is a flow chart of an application method of the color sensing device according to one embodiment of the present disclosure.

FIGS. 13A-13C are experimental data graphs of the color sensing device according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

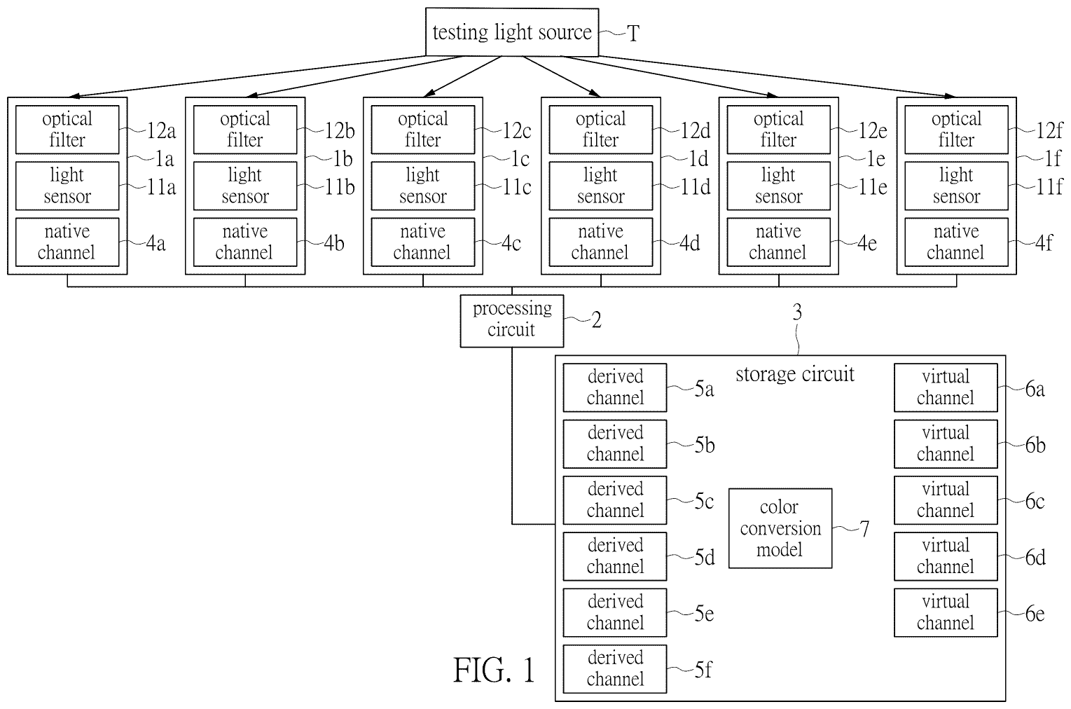

FIG. 1 is a schematic diagram of a color sensing device according to a first embodiment of the present disclosure. Referring to FIG. 1, the color sensing device is configured to generate a color coordinate of a testing light source T. The color sensing device includes a plurality of light sensing elements 1a-1f, a processing circuit 2 and a storage circuit 3. The processing circuit 2 is electrically connected to the light sensing elements 1a-1f and the storage circuit 3.

The processing circuit 2 is, for example, one or any combination of a central processing unit, a digital signal processor, an embedded controller, an application-specific integrated circuit, a field programmable gate array, a microprocessor, and a microcontroller.

The storage circuit 3 is, for example, one or any combination of a programmable read-only memory, an erasable programmable read-only memory, and a flash memory.

The light sensing elements 1a-1f respectively include a plurality of light sensors 11a-11f and a plurality of optical filters 12a-12f corresponding to the light sensors 11a-11f. The optical filters 12a-12f have respective specific wavelength ranges, and the optical filters 12a-12f are respectively located in front of the light sensors 11a-11f for filtering incident lights. The optical filter is, for example, a band pass filter. The portion of incident light that is within the specific wavelength range can be allowed to pass through the band pass filter, and the portion of incident light that is not within the specific wavelength range is blocked, absorbed or reflected. Thereby, the light sensing elements 1a-1f correspond to a plurality of distinct native channels 4a-4f.

Specifically, each of the native channels has a peak, and native channels partially overlap each other to generate a plurality of intersection points. The native channel which corresponds to one intersection point defines a center area and one edge area. The native channel which corresponds to two intersection points defines a center area and two edge areas. Preferably, a ratio of sensing value of any one of the intersection points to sensing value of any one of the peaks which are adjacent to the intersection point is between 0.02 and 0.9.

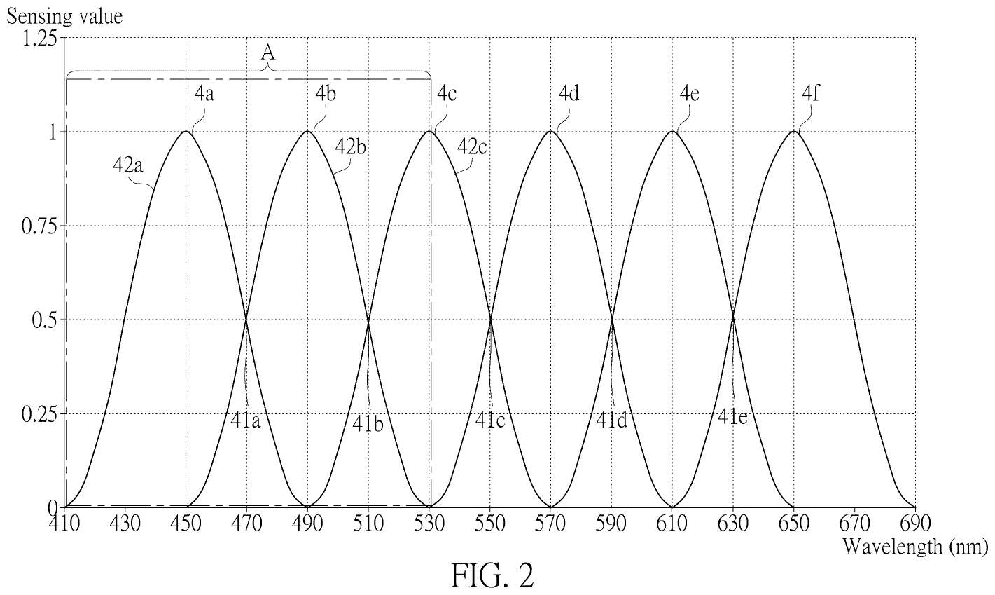

FIG. 2 is a schematic diagram of sensing distributions of native channels according to the first embodiment of the present disclosure. Referring to FIGS. 1 and 2, the processing circuit 2 is configured to normalize the native channels 4a-4f, so that sensing value of the peak of each of the native channels 4a-4f is 1. The native channels 4a-4f partially overlap with each other to generate a plurality of intersection points 41a-41e, and sensing value of each of the intersection points 41a-41e is 0.5.

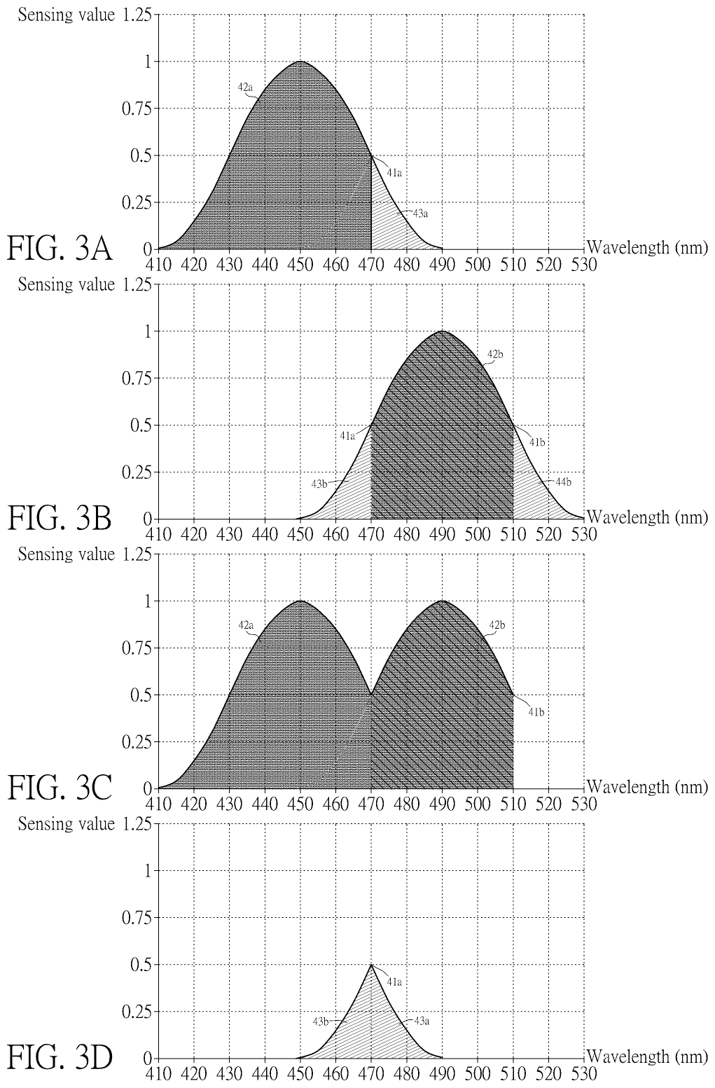

FIGS. 3A-3D are spectrum diagrams of a part A of FIG. 2. Referring to FIG. 3A, the native channel 4a defines a central area 42a corresponding to the intersection point 41a, and a wavelength range of the central area 42a is 410 nm-470 nm. The native channel 4a defines an edge area 43a corresponding to the intersection point 41a, and a wavelength range of the edge area 43a is 470 nm-490 nm. Referring to FIG. 3B, the native channel 4b defines a central area 42b corresponding to the intersection points 41a and 41b, and a wavelength range of the central area 42b is 470 nm-510 nm. The native channel 4b defines two edge areas 43b and 44b corresponding to the intersection points 41a and 41b. A wavelength range of the edge area 43b is 450 nm-470 nm, and a wavelength range of the edge area 44b is 510 nm-530 nm.

The native channel which is located at the edge region has one intersection point and thus defines one central area and one edge area. The native channel which is located in a middle region has two intersection points and thus defines one central area and two edge areas.

Referring to FIG. 3A, a sensing distribution of the central area 42a of the native channel 4a is 81.3% of a sensing distribution of the native channel 4a. A sensing distribution of the edge area 43a of the native channel 4a is 18.7% of the sensing distribution of the native channel 4a. The processing circuit 2 establishes a derived channel 5a according to the central area 42a of the native channel 4a. Since the wavelength range of the central region 42a of the native channel 4a is 410 nm-470 nm, the wavelength range of the derived channel 5a is 410 nm-470 nm.

The processing circuit 2 simultaneously generates the sensing distribution of the derived channel 5a based on the sensing distribution of the central area 42a of the native channel 4a. The sensing distribution of the central area 42a of the native channel 4a is based on 81.3% of the sensing distribution of the original channel 4a. Therefore, the sensing distribution of the derived channel 5a is based on 81.3% of the sensing distribution of the native channel 4a.

Referring to FIG. 3B, the sensing distribution of the central area 42b of the native channel 4b is based on 62.6% of the sensing distribution of the native channel 4b, and the sensing distribution of the edge area 43b of the native channel 4b is based on 18.7% of the sensing distribution of the native channel 4b. The sensing distribution of the edge region 44b of the native channel 4b is based on 18.7% of the sensing distribution of the native channel 4b. The processing circuit 2 is configured to establish a derived channel 5b according to the central region 42b of the native channel 4b. Since the wavelength range of the central region 42b of the native channel 4b is 470 nm-510 nm, the wavelength range of the derived channel 5b is 470 nm-510 nm.

The processing circuit 2 simultaneously generates the sensing distribution of the derived channel 5b based on the sensing distribution of the central area 42b of the native channel 4b. The sensing distribution of the central area 42b of the native channel 4b is based on 62.6% of the sensing distribution of the native channel 4b. Therefore, the sensing distribution of derived channel 5b is based on 62.6% of the sensing distribution of the native channel 4b.

Referring to FIG. 3C, since the native channel 4a only defines one intersection point, the sensing distribution of the central area 42a is greater than the sensing distribution of the central area 42b of the native channel 4b.

Referring to FIG. 3D, the processing circuit 2 is configured to establish a virtual channel 6a according to the edge area 43a of the native channel 4a and the edge area 43b of the native channel 4b. Since the wavelength range of the edge region 43a of the native channel 4a is 470 nm-490 nm and the wavelength range of the edge region 43b of the native channel 4b is 450 nm-470 nm, the wavelength range of the virtual channel 6a is 450 nm-490 nm.

The processing circuit 2 simultaneously corresponds to the sensing distribution of the edge area 43a of the native channel 4a and the sensing distribution of the edge area 43b of the native channel 4b to generate the sensing distribution of the virtual channel 6a. In other words, the sum of 18.7% of the sensing distribution of the native channel 4a, and 18.7% of the sensing distribution of the native channel 4b is equal to the sensing distribution of the virtual channel 6a.

The processing circuit 2 is configured to respectively establish the derived channels 5a-5f according to a plurality of central areas and store the derived channels 5a-5f in the storage circuit 3. The processing circuit 2 is configured to establish the virtual channels 6a-6e according to a plurality of edge areas and store the virtual channels 6a-6e in the storage circuit 3. Among them, the number of derived channels 5a-5f is greater than the number of virtual channels 6a-6e.

Preferably, the present disclosure can be particularly suitable for a color sensing device with relatively separated native channels, that is, each native channel only overlaps with the adjacent native channel and does not overlap with the next adjacent native channel. In this case, the virtual channels do not overlap with each other. However, the present disclosure is not limited thereto, and a color sensing device in which each native channel overlaps with the next adjacent native channel can also be used.

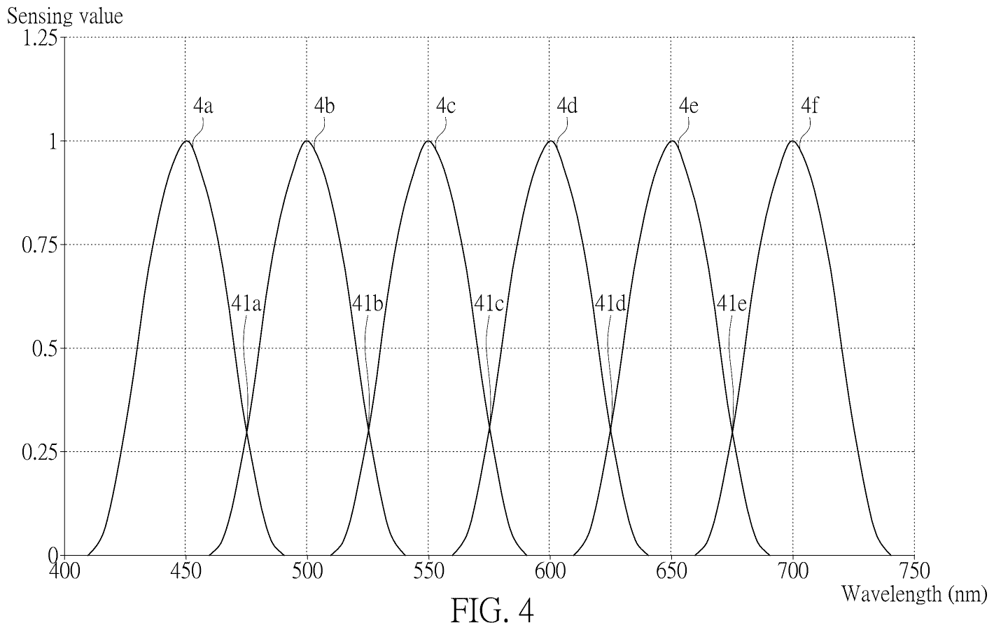

FIG. 4 is a schematic diagram of the sensing distributions of native channels according to a second embodiment of the present disclosure. Comparing FIG. 4 with FIG. 2, their difference is that the sensing values of intersection points 41a-41e are 0.3, respectively.

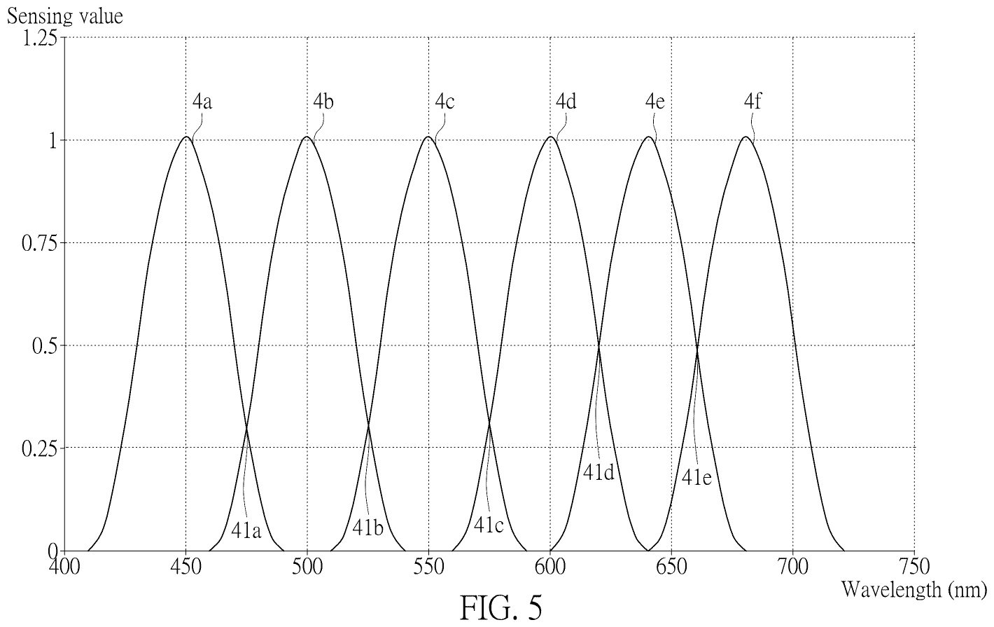

FIG. 5 is a schematic diagram of the sensing distributions of native channels according to a third embodiment of the present disclosure. Comparing FIG. 5 with FIG. 2, their difference is that the sensing values of the intersection points 41a-41e are not exactly the same. The sensing values of the intersection points 41a-41c are 0.3 respectively, and the sensing values of the intersection points 41d-41e are 0.5 respectively.

Referring again to FIG. 1, the light sensing elements 1a-1f are configured to detect the testing light source T and generate a plurality of initial responses. The processing circuit 2 is configured to convert the initial responses into a plurality of derived responses of the derived channels 5a-5f and a plurality of virtual responses of the virtual channels 6a-6e.

In detail, the processing circuit 2 converts the initial response of the central area 42a of the native channel 4a into the derived response of the derived channel 5a, and based on the initial response of the primary channel 4a in the edge area 43a, converts the sum of the initial response of the edge area 43a of the native channel 4a and the initial response of the edge area 43b of the native channel 4b into the virtual response of virtual channel 6a.

The storage circuit 3 also stores a color conversion model 7, in which the color conversion model 7 includes a plurality of weight values. Roughly speaking, the color conversion model 7 is a trained model, and the derived responses of the derived channels 5a-5f and the virtual responses of the virtual channels 6a-6e are used as input data of the color conversion model 7, and output data of the conversion model 7 is a color coordinate of the testing light source T, such as a CIE chromaticity coordinate.

The color conversion model 7 is, for example, a conversion matrix (3×11). The derived responses of the derived channels 5a-5f and the virtual responses of the virtual channels 6a-6e form a response matrix (11×1). The processing circuit 2 is configured to calculate an inner product of the response matrix and the conversion matrix to generate the color coordinate of the testing light source T.

The color conversion model 7 is, for example, a trained convolutional neural network model, and the processing circuit 2 is configured to input the derived responses of the derived channels 5a-5f and the virtual responses of the virtual channels 6a-6e to the convolutional neural network model, and output data of the convolutional neural network model is the color coordinate of the testing light source T.

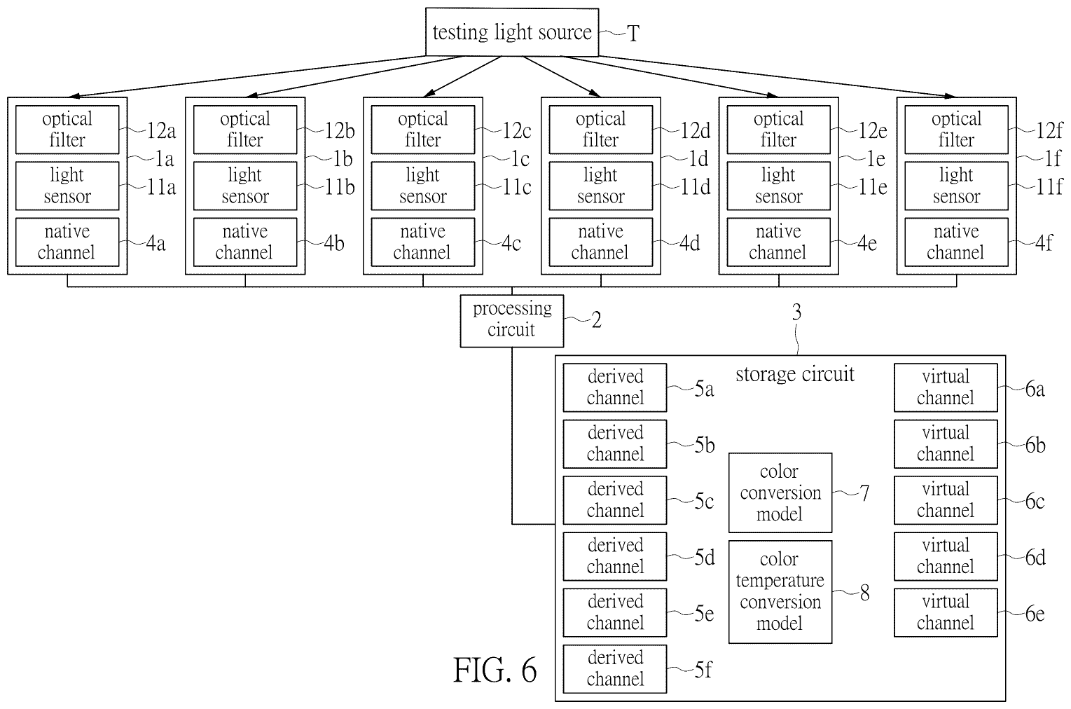

FIG. 6 is a schematic diagram of a color sensing device according to the second embodiment of the present disclosure. Comparing FIG. 6 with FIG. 1, their difference is that the color sensing device of FIG. 6 further includes a color temperature conversion model 8. The storage circuit 3 stores the color temperature conversion model 8, wherein the color temperature conversion model 8 includes a plurality of weight values. Roughly speaking, the color temperature conversion model 8 is a trained model, and the derived responses of the derived channels 5a-5f and the virtual responses of the virtual channels 6a-6e are used as input data of the color temperature conversion model 8, and output data of the color temperature conversion model 8 is a color temperature of the testing light source T.

The present disclosure also provides an optimization method of the color sensing device, which can be implemented on the color sensing devices of FIG. 1 and FIG. 6. The optimization method of the color sensing device provided by the present disclosure includes a model training method, a calibration method, and an application method.

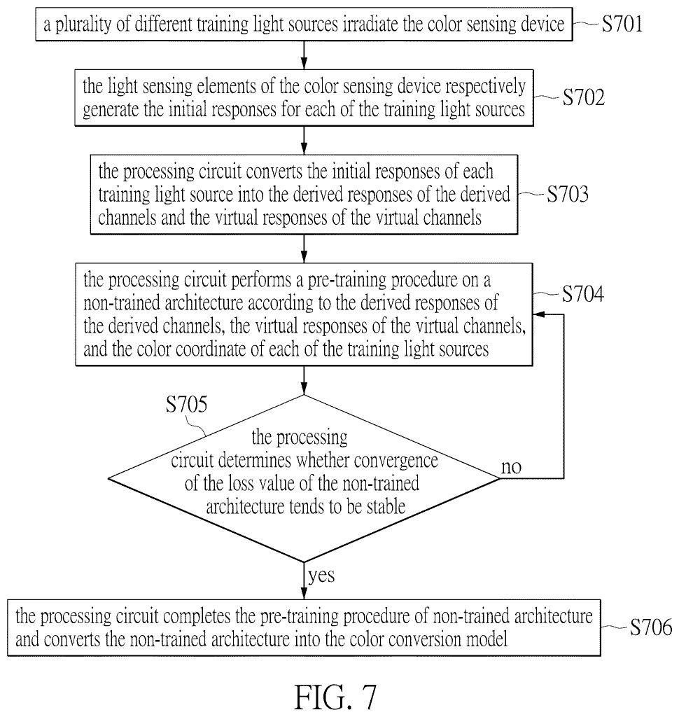

FIG. 7 is a flow chart of a model training method of the color sensing device according to one embodiment of the present disclosure. Referring to FIG. 7, in step S701, a plurality of different training light sources irradiate the color sensing device.

In step S702, the light sensing elements 1a-1f of the color sensing device respectively generate the initial responses for each of the training light sources.

In step S703, the processing circuit 2 converts the initial responses of each training light source into the derived responses of the derived channels 5a˜5f and the virtual responses of the virtual channels 6a˜6e.

In step S704, the processing circuit 2 performs a pre-training procedure on a non-trained architecture according to the derived responses of the derived channels 5a-5f, the virtual responses of the virtual channels 6a-6e, and the color coordinate of each of the training light sources.

Specifically, the derived responses of the derived channels 5a-5f and the derived responses of the virtual channels 6a-6e are used as input data of the non-trained architecture, and the color coordinate of each of the training light sources is used as a reference answer. The processing circuit 2 calculates a loss value between output data of the non-trained architecture and the reference answer, and corrects one or more weight values of the non-trained architecture based on the loss value.

In step S705, the processing circuit 2 determines whether convergence of the loss value of the non-trained architecture tends to be stable. If yes, step S705 is followed by step S706. If not, the training method returns to step S704. In step S706, the processing circuit 2 completes the pre-training procedure of non-trained architecture and converts the non-trained architecture into the color conversion model 7.

In other embodiments of the model training method, the color temperature of each of the training light sources can also be labeled according to the color coordinate of each of the training light sources. The derived responses of the derived channels 5a-5f and the virtual responses of the virtual channels 6a-6e are used as input data of the non-trained architecture, and the color temperature of each of the training light sources is used as a reference answer. The processing circuit 2 calculates the loss value between output data of the non-trained architecture and the reference answer, and one or more weight values of the non-trained architecture are corrected according on the loss value. When the convergence of the loss value of the non-trained architecture becomes stable, the processing circuit 2 completes the pre-training procedure of the non-trained architecture and converts the non-trained architecture into the color temperature conversion model 8.

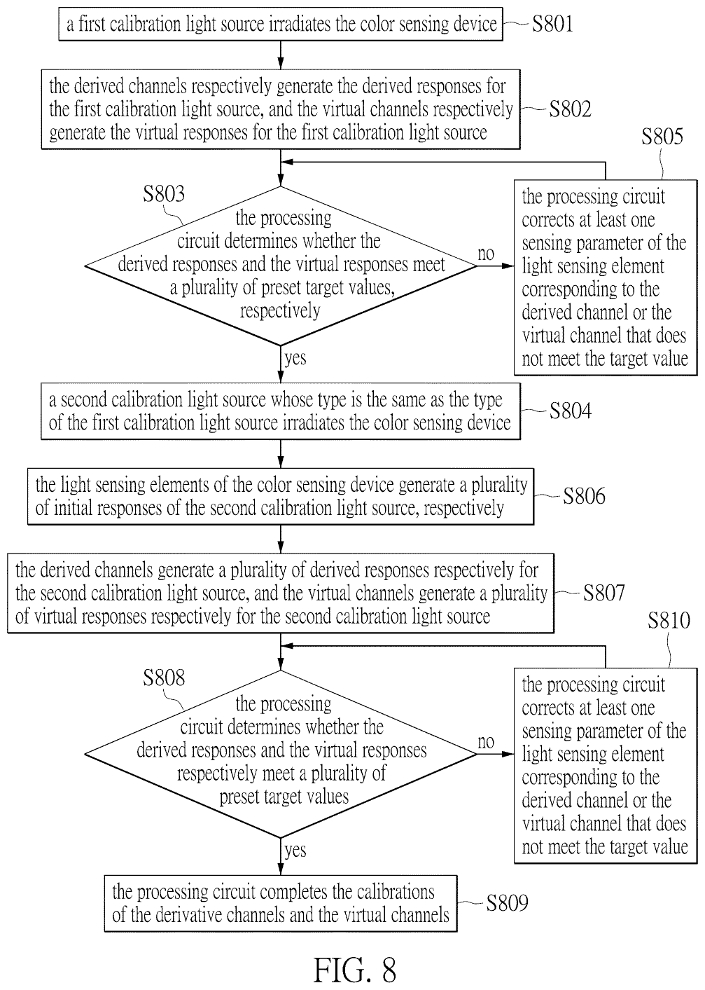

FIG. 8 is a flow chart of a calibration method of the color sensing device according to the first embodiment of the present disclosure, and the calibration method of FIG. 8 is achieved by calibrating hardware parameters.

Referring to FIG. 8, in step S801, a first calibration light source irradiates the color sensing device.

In step S802, the derived channels 5a-5f respectively generate the derived responses for the first calibration light source, and the virtual channels 6a-6e respectively generate the virtual responses for the first calibration light source.

In step S803, the processing circuit 2 determines whether the derived responses and the virtual responses meet a plurality of preset target values, respectively. If yes, step S803 is followed by step S804. If not, step S803 is followed by step S805.

Specifically, for the same light source, the derived channels 5a-5f and the virtual channels 6a-6e correspond to target values, respectively. For example, the target value of derived channel 5a is 100, the target value of derived channel 5b is 110, and the target value of virtual channel 6a is 105.

In step S804, a second calibration light source whose type is the same as the type of the first calibration light source irradiates the color sensing device. For example, the first calibration light source and the second calibration light source are visible light sources, respectively, but the visible light sources have different intensities. However, the present disclosure is not limited thereto, and the calibration light source can also be an infrared light source or an ultraviolet light source.

In step S805, the processing circuit 2 corrects at least one sensing parameter of the light sensing element corresponding to the derived channel or the virtual channel that does not meet the target value, and then the calibration method returns to step S803.

In step S806, the light sensing elements 1a-1f of the color sensing device generate a plurality of initial responses of the second calibration light source, respectively.

In step S807, the derived channels 5a-5f generate a plurality of derived responses respectively for the second calibration light source, and the virtual channels 6a-6e generate a plurality of virtual responses respectively for the second calibration light source.

In step S808, the processing circuit 2 determines whether the derived responses and the virtual responses respectively meet a plurality of preset target values.

If yes, step S808 is followed by step S809. If not, step S808 is followed by step S810.

In step S809, the processing circuit 2 completes the calibrations of the derivative channels 5a-5f and the virtual channels 6a-6e.

In step S810, the processing circuit 2 corrects at least one sensing parameter of the light sensing element corresponding to the derived channel or the virtual channel that does not meet the target value, and then the calibration method returns to step S808.

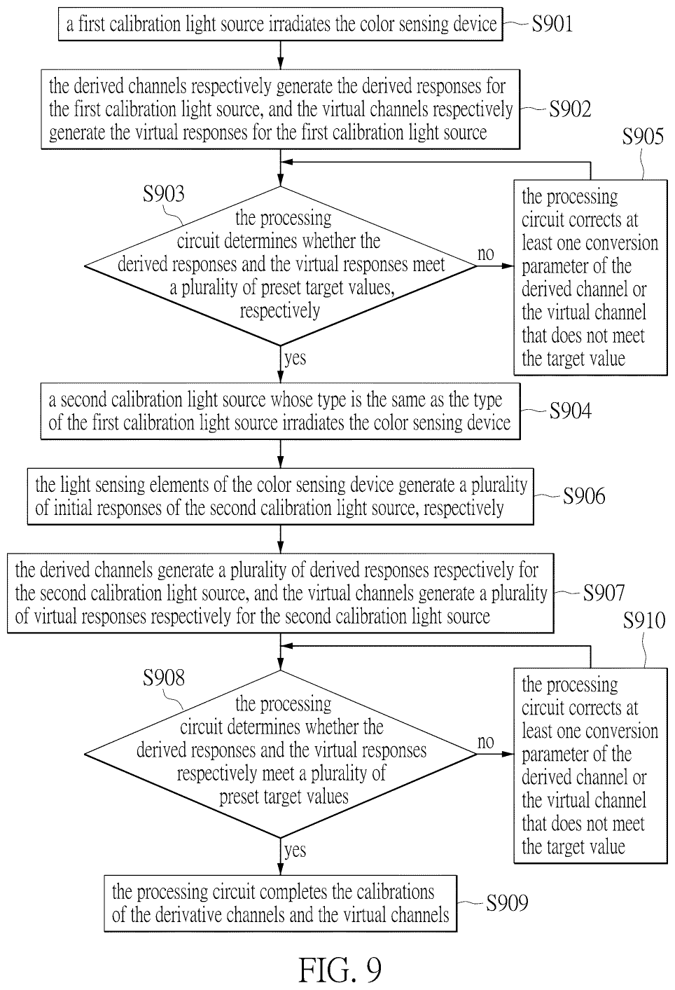

FIG. 9 is a flow chart of the calibration method of the color sensing device according to the second embodiment of the present disclosure, and the calibration method of FIG. 9 is achieved by calibrating software parameters.

The calibration method of FIG. 9 includes steps S901-S910. Comparing FIG. 9 with FIG. 8, their differences are step S905 and step S910, the processing circuit 2 corrects at least one conversion parameter of the derived channel or the virtual channel that does not meet the target value.

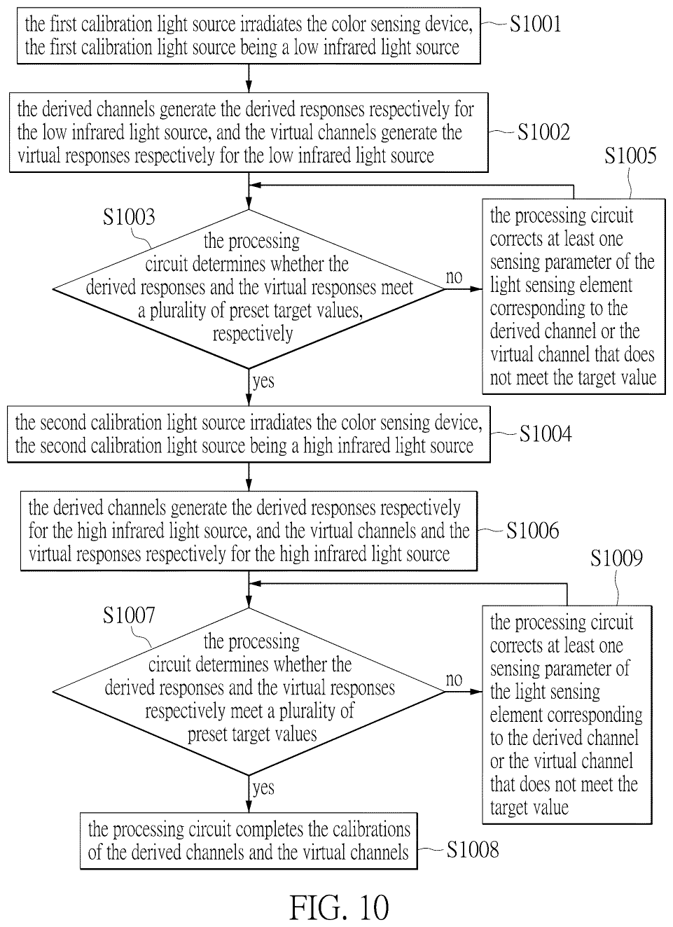

FIG. 10 is a flow chart of the calibration method of the color sensing device according to a third embodiment of the present disclosure, and the calibration method of FIG. 10 is achieved by calibrating hardware parameters.

Referring to FIG. 10, in step S1001, the first calibration light source irradiates the color sensing device, the first calibration light source being a low infrared light source.

In step S1002, the derived channels 5a-5f generate the derived responses respectively for the low infrared light source, and the virtual channels 6a-6e generate the virtual responses respectively for the low infrared light source.

In step S1003, the processing circuit 2 determines whether the derived responses and the virtual responses meet a plurality of preset target values, respectively. If yes, step S1003 is followed by step S1004. If not, step S1003 is followed by step S1005.

In step S1004, the second calibration light source irradiates the color sensing device, the second calibration light source being a high infrared light source.

In step S1005, the processing circuit 2 corrects at least one sensing parameter of the light sensing element corresponding to the derived channel or the virtual channel that does not meet the target value, and then the calibration method returns to step S1003.

In step S1006, the derived channels 5a-5f generate the derived responses respectively for the high infrared light source, and the virtual channels 6a-6e and the virtual responses respectively for the high infrared light source.

In step S1007, the processing circuit 2 determines whether the derived responses and the virtual responses respectively meet a plurality of preset target values.

If yes, step S1007 is followed by step S1008. If not, step S1007 is followed by step S1009.

In step S1008, the processing circuit 2 completes the calibrations of the derived channels 5a-5f and the virtual channels 6a-6e.

In step S1009, the processing circuit 2 corrects at least one sensing parameter of the light sensing element corresponding to the derived channel or the virtual channel that does not meet the target value, and then the calibration method returns to step S1007.

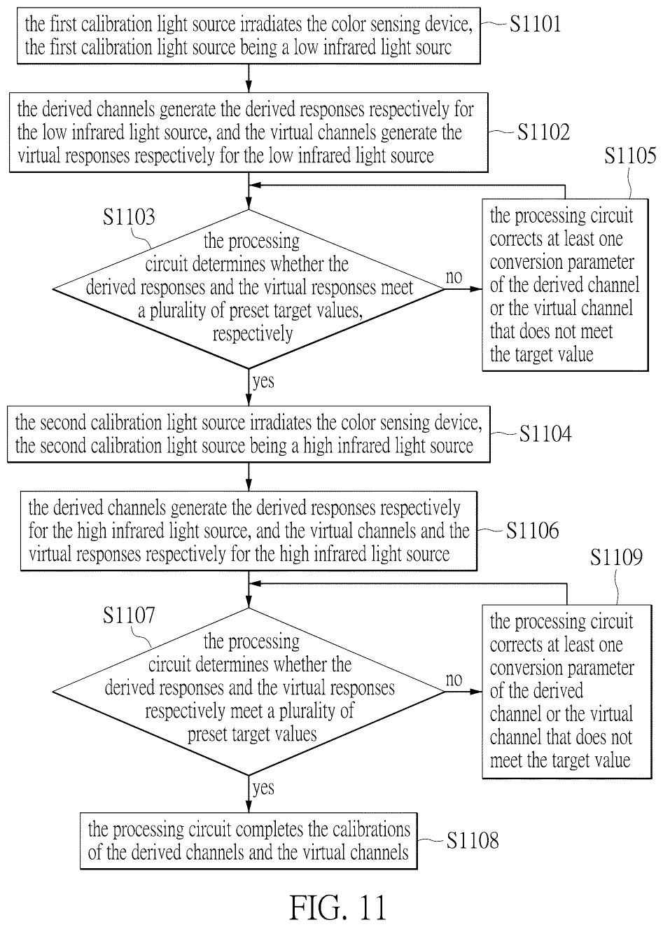

FIG. 11 is a flow chart of the calibration method of the color sensing device according to a fourth embodiment of the present disclosure, and the calibration method of FIG. 11 is achieved by calibrating software parameters.

The calibration method of FIG. 11 includes steps S1101-S1109. Comparing FIG. 11 with FIG. 10, their differences are step S1105 and step S1009, the processing circuit 2 corrects at least one conversion parameter of the derived channel or the virtual channel that does not meet the target value.

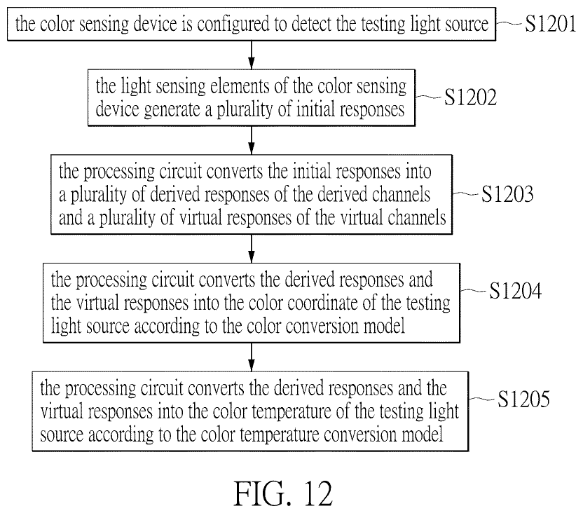

FIG. 12 is a flow chart of an application method of the color sensing device according to one embodiment of the present disclosure. Referring to FIG. 12, in step S1201, the color sensing device is configured to detect the testing light source T.

In step S1202, the light sensing elements 1a-1f of the color sensing device generate a plurality of initial responses.

In step S1203, the processing circuit 2 converts the initial responses into a plurality of derived responses of the derived channels 5a-5f and a plurality of virtual responses of the virtual channels 6a-6e.

In step S1204, the processing circuit 2 converts the derived responses and the virtual responses into the color coordinate of the testing light source T according to the color conversion model 7.

Step S1205, the processing circuit 2 converts the derived responses and the virtual responses into the color temperature of the testing light source T according to the color temperature conversion model 8.

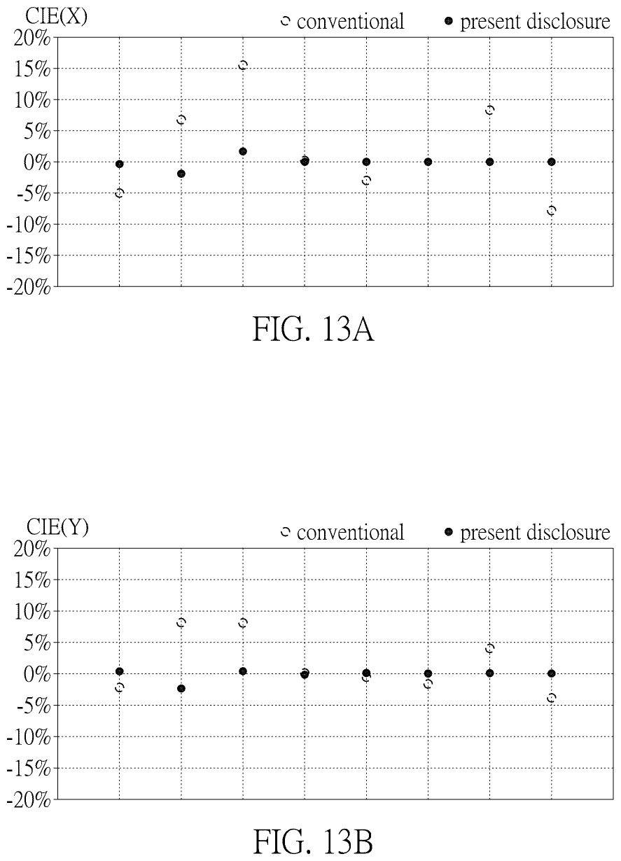

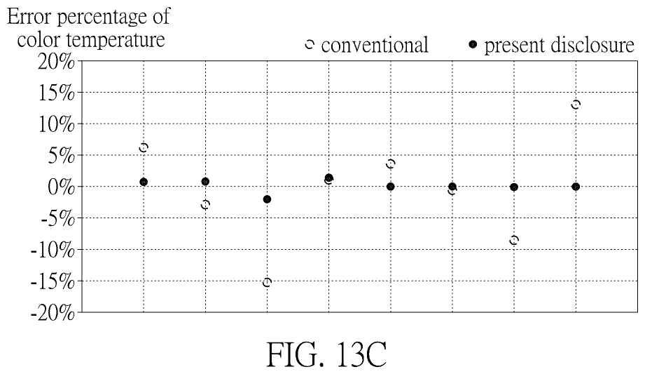

FIGS. 13A-13D are experimental data graphs of the color sensing device according to one embodiment of the present disclosure. A conventional color sensing device has 6 usable spectral channels. The optimization method of the color sensing device of the present disclosure is performed on the conventional color sensing device, thereby producing the color sensing device of the present disclosure, and the color sensing device of the present disclosure has 11 usable spectral channels.

As shown in FIG. 13A, for prediction of the X value of the CIE color coordinate, the error percentage of the color sensing device of the present disclosure is between ±2%, while the error percentage of the conventional color sensing device is between ±16%.

As shown in FIG. 13B, for prediction of the Y value of the CIE color coordinate, the error percentage of the color sensing device of the present disclosure is between ±2%, while the error percentage of the conventional color sensing device is between ±8%.

As shown in FIG. 13C, for prediction of the color temperature, the error percentage of the color sensing device of the present disclosure is between ±4%, while the error percentage of the conventional color sensing device is between ±30%.

According to the above experimental data, it can be seen that the color sensing device of the present disclosure has better performance in predicting the color coordinate and the color temperature.

### BENEFICIAL EFFECTS OF THE EMBODIMENTS

In conclusion, in the color sensing device and the optimization method of the color sensing device provided by the present disclosure, the number of spectral channels of the color sensing device are increased without increasing hardware cost and production cycle. By way of incrementing the number of spectral channels, the color sensing device has higher resolution, higher sensitivity, more accurate information analysis, and higher yields.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A color sensing device, comprising:
a plurality of light sensing elements, wherein the light sensing elements have a plurality of distinct native channels, each of the native channels has a peak, and any two of the adjacent native channels partially overlap with each other and defines an intersection point, each of the native channels corresponds to the one or two of the intersection points to define a central area and one or two edge areas;
a processing circuit electrically connected to the light sensing elements; and
a storage circuit electrically connected to the processing circuit and storing a color conversion model;
wherein the light sensing elements are configured to detect a testing light source and generate a plurality of initial responses;
wherein the processing circuit is configured to establish a plurality of derived channels based on the peaks and establish a plurality of virtual channels based on the intersection points;
wherein the processing circuit is configured to convert the initial responses into a plurality of derived responses of the derived channels and a plurality of virtual responses of the virtual channel;
wherein the processing circuit is configured to access the storage circuit to execute the color conversion model;
wherein the color conversion model is configured to generate a color coordinate of the testing light source based on the derived responses and the virtual responses.

2. The color sensing device according to claim 1, wherein a sensing distribution of each of the derived channels is based on a sensing distribution of the central area of the native channel corresponding to the derived channel.

3. The color sensing device according to claim 1, wherein a sensing distribution of each of the virtual channels is based on a sum of sensing distributions of the two edge areas of the two native channels at the intersection point based on which the virtual channel is established.

4. The color sensing device according to claim 1, wherein a quantity of the derivative channels is greater than a quantity of the virtual channels.

5. The color sensing device according to claim 1, wherein the virtual channels do not overlap with each other.

6. The color sensing device according to claim 1, wherein sensing values of the intersection points are same after the native channels are normalized.

7. The color sensing device according to claim 1, sensing values of the intersection points are not all same after the native channels are normalized.

8. The color sensing device according to claim 1, wherein a ratio of a sensing value of any one of the intersection points to a sensing value of any one of the peaks which are adjacent to the intersection point is between 0.02 and 0.9.

9. The color sensing device according to claim 1, wherein each of the light sensing elements includes a light sensor and a light filter.

10. The color sensing device according to claim 1, wherein the processing circuit is configured to generate a color temperature of the testing light source according to a color temperature conversion model.

11. An optimization method of a color sensing device, comprising:
detecting, by a plurality of light sensing elements, a testing light source to generate a plurality of initial responses;
wherein the light sensing elements have a plurality of distinct native channels, each of the native channels has a peak, and any two of the native channels that are adjacent partially overlap with each other and defines an intersection point, each of the native channels corresponds to one or two of the intersection points to define a central area of the native channel and one or two edge areas of the native channel;
establishing, by a processing circuit, a plurality of derivative channels according to a plurality of the peaks;
establishing, by the processing circuit, a plurality of virtual channels according to the one intersection point or the two intersection points;
converting, by the processing circuit, a plurality of the initial responses into a plurality of derived responses of the derived channels and a plurality of virtual responses of the virtual channels;
accessing, by a storage circuit, the processing circuit to execute a color conversion model;
generating, by the color conversion model, a color coordinate of the testing light source according to the derived responses and the virtual responses.

12. The optimization method according to claim 11, wherein a sensing distribution of each of the derived channels is based on a sensing distribution of the central area of the native channel corresponding to the derived channel.

13. The optimization method according to claim 11, wherein a sensing distribution of each of the virtual channels is based on a sum of sensing distributions of the two edge areas of the two native channels at the intersection point based on which the virtual channel is established.

14. The optimization method according to claim 11, wherein sensing values of the intersection points are same after the native channels are normalized.

15. The optimization method according to claim 11, wherein a ratio of a sensing value of any one of the intersection points to a sensing value of any one of the wave peaks which are adjacent to the intersection point is between 0.02 and 0.9.

16. The optimization method according to claim 11, further comprising: irradiating the color sensing device by a plurality of distinct training light sources; generating the derived responses and the virtual responses corresponding to each of the training light sources; executing, by the processing circuit, a pre-training procedure for an untrained architecture to obtain the color conversion model according to the derived responses, the virtual responses, and a color coordinate of each of the training light sources.

17. The optimization method according to claim 11, further comprising: irradiating the color sensing device by a plurality of calibration light sources; generating the derived responses and the virtual responses respectively for each of the calibration light sources according to the derived channels and the virtual channels; determining, by the processing circuit, whether the derived responses and the virtual responses comply with a plurality of preset target values respectively; correcting at least one sensing parameter of the light sensing element corresponding to the derived channel or the virtual channel until the derived response or the virtual response complies with the target value when any one of the derived responses or the virtual responses does not comply with the preset target value.

18. The optimization method according to claim 11, further comprising: irradiating the color sensing device by a plurality of calibration light sources; generating the derived responses and the virtual responses respectively for each of the calibration light sources according to the derived channels and the virtual channels; determining, by the processing circuit, whether the derived responses and the virtual responses comply with a plurality of preset target values respectively; correcting at least one conversion parameter of the derived channel or the virtual channel until the derived response or the virtual response complies with the target value when any one of the derived responses or the virtual responses does not comply with the preset target value.

19. The optimization method according to claim 17, wherein the calibration light sources are with same type.

20. The optimization method according to claim 18, wherein the calibration light sources are with same type.

21. The optimization method according to claim 17, wherein the calibration light sources are with two different types, one of the calibration light sources is a low infrared light source and another one of the calibration light sources is a high infrared light source.

22. The optimization method according to claim 18, wherein the calibration light sources are with two different types, one of the calibration light sources is a low infrared light source and another one of the calibration light sources is a high infrared light source.
